(19) United States
(12) Patent Application Publication
(10) Pub. No.: US 2019/0347495 A1
(43) Pub. Date: Nov. 14, 2019

(54) Vehicle Mounted Imaging Assembly

(71) Applicant: Randy Martin, Duarte, CA (US)

(72) Inventor: Randy Martin, Duarte, CA (US)

(21) Appl. No.: 15/974,683

(22) Filed: May 8, 2018

(51) Int. Cl. G06K 9/00; H04N 5/225; B60R 1/04; B60R 1/06; H04N 7/18

(52) U.S. Cl. CPC G06K 9/00805; H04N 5/2252; B60R 1/04; H01M 10/44; H04N 7/181; B60R 2300/105; B60R 1/06

(57) ABSTRACT

A vehicle mounted imaging assembly for accident prevention and documentation, car recovery, and perpetrator identification includes a plurality of sensing and imaging modules and a control unit that comprises a receiver. Each sensing and imaging module comprises a coupler, which is coupled to a first housing and configured to couple to a vehicle. A first power module, a first microprocessor, a transmitter imager, and a motion detector are coupled to the first housing, with the former two positioned in the first housing. The first microprocessor is operationally coupled to the first power module. The motion detector, the imager, and the transmitter are operationally coupled to the first microprocessor. The motion detector is configured to detect an object moving in an area proximate to the first housing, positioning the first microprocessor to actuate the imager to capture, and the transmitter to transmit, an image of the object to the control unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to imaging assemblies and more particularly pertains to a new imaging assembly for accident prevention and documentation, car recovery, and perpetrator identification.

### BRIEF SUMMARY OF THE INVENTION

An embodiment of the disclosure meets the needs presented above by generally comprising a plurality of sensing and imaging modules and a control unit that comprises a receiver. Each sensing and imaging module comprises a coupler, which is coupled to a first housing and configured to couple to a vehicle. A first power module, a first microprocessor, a transmitter imager, and a motion detector are coupled to the first housing, with the former two positioned in the first housing. The first microprocessor is operationally coupled to the first power module. The motion detector, the imager, and the transmitter are operationally coupled to the first microprocessor. The motion detector is configured to detect an object moving in an area proximate to the first housing, positioning the first microprocessor to actuate the imager to capture, and the transmitter to transmit, an image of the object to the control unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vehicle mounted imaging assembly according to an embodiment of the disclosure.

FIG. 2 is an isometric perspective view of an embodiment of the disclosure.

FIG. 3 is a front view of an embodiment of the disclosure.

FIG. 4 is a side view of an embodiment of the disclosure.

FIG. 5 is a top view of an embodiment of the disclosure.

FIG. 6 is a block diagram of an embodiment of the disclosure.

### DETAILED DESCRIPTION OF THE INVENTION

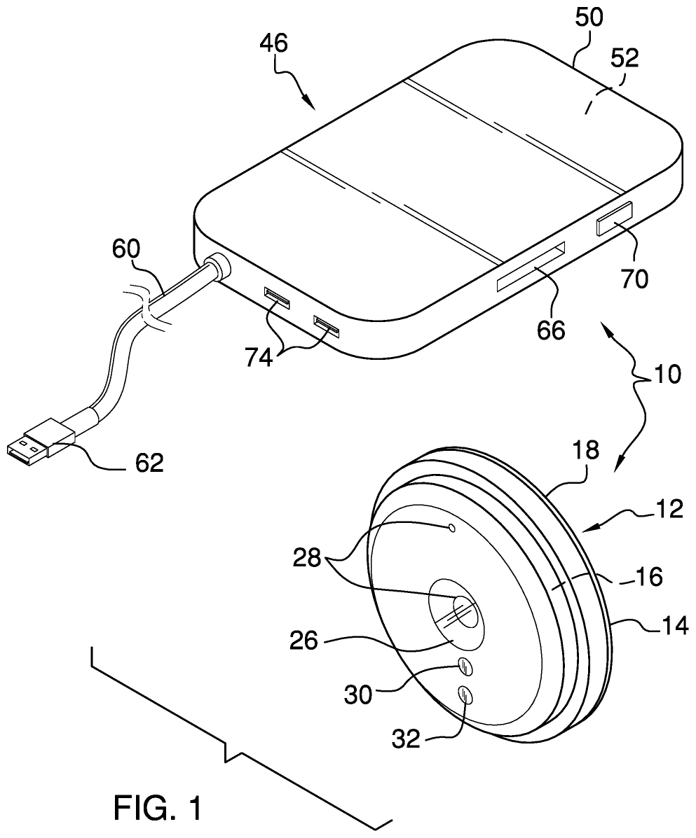

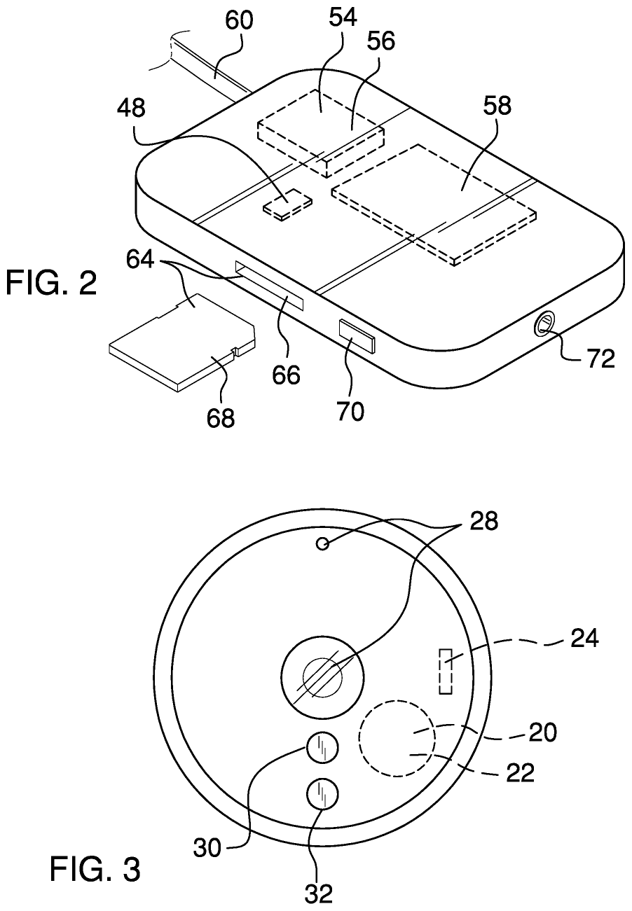

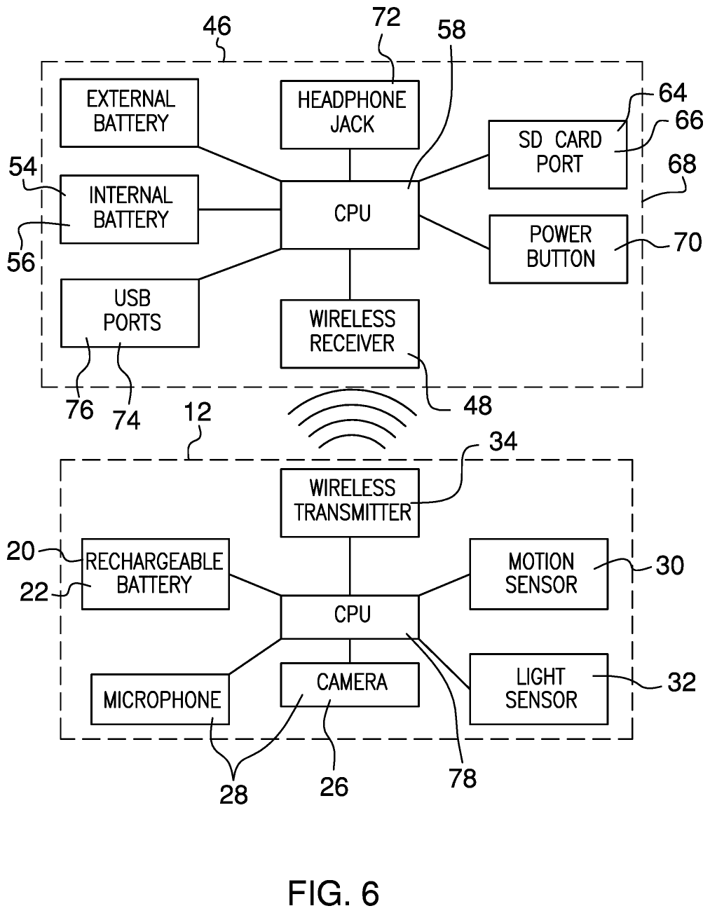

With reference now to the drawings, and in particular to FIGS. 1 through 6 thereof, a new imaging assembly embodying the principles and concepts of an embodiment of the disclosure and generally designated by the reference numeral 10 will be described.

As best illustrated in FIGS. 1 through 6, the vehicle mounted imaging assembly 10 generally comprises a plurality of sensing and imaging modules 12. Each sensing and imaging module 12 comprises a first housing 14 that defines an interior space 16. The first housing 14 is substantially disc shaped. A coupler 18 is coupled to the first housing 14. The coupler 18 is configured to couple the first housing 14 to a vehicle.

A first power module 20 is coupled to the first housing 14 and is positioned in the interior space 16. The first power module 20 comprises a first battery 22. The first battery 22 is rechargeable. A charging port 24 is coupled to the first housing 14. The charging port 24 is operationally coupled to the first battery 22. The charging port 24 is configured to couple the first battery 22 to a source of direct current to charge the first battery 22.

A first microprocessor 78 is coupled to the first housing 14 and is positioned in the interior space 16. An imager 26 is coupled to the first housing 14. The imager 26 is operationally coupled to the first power module 20 and the first microprocessor 78. The imager 26 is configured to capture an image of an area proximate to the first housing 14. The imager 26 comprises an audiovisual camera 28. The audiovisual camera 28 is configured to capture an audiovisual image of the area proximate to the first housing 14.

A motion detector 30 is coupled to the first housing 14. The motion detector 30 is operationally coupled to the first power module 20 and the first microprocessor 78. The motion detector 30 is configured to detect an object moving in the area proximate to the first housing 14, positioning the first microprocessor 78 to actuate the imager 26 to capture the image of the object.

A photosensor 32 is coupled to the first housing 14. The photosensor 32 is operationally coupled to the first power module 20 and the first microprocessor 78. The photosensor 32 is configured to measure a light level proximate to the first housing 14, positioning the first microprocessor 78 to actuate the imager 26 for night vision mode.

A transmitter 34 is coupled to the first housing 14 and is positioned in the interior space 16. The transmitter 34 is operationally coupled to the first power module 20 and the first microprocessor 78. The transmitter 34 is positioned to transmit the image.

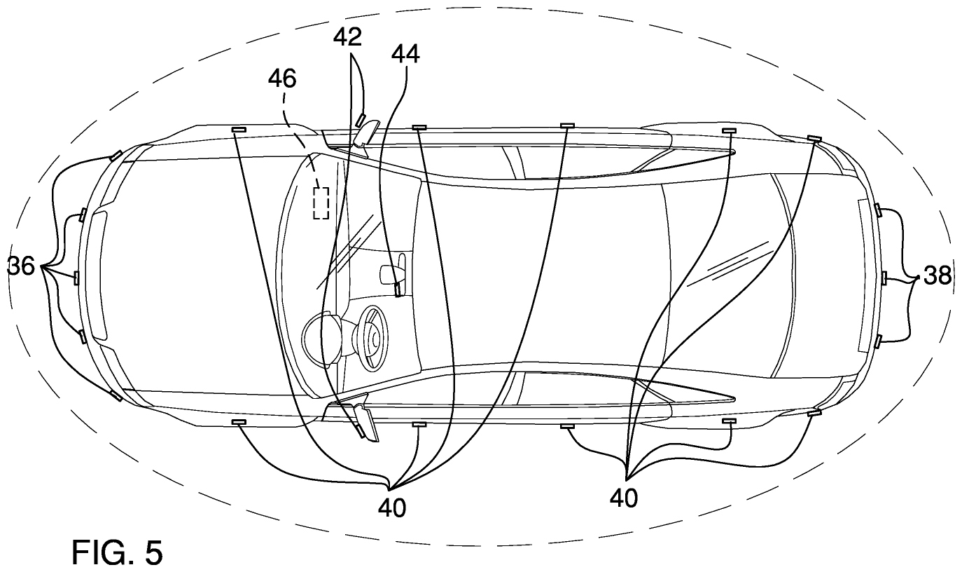

The plurality of sensing and imaging modules 12 comprises a plurality of forward units 36 that is mounted to a front of the vehicle, as shown in FIG. 5. The plurality of forward units 36 comprises five forward units 36. The plurality of sensing and imaging modules 12 also comprises a plurality of rearward units 38 that is mounted to a back of the vehicle, as shown in FIG. 5. The plurality of rearward units 38 comprises three rearward units 38. The plurality of sensing and imaging modules 12 also comprises a plurality of side units 40 that is mounted to opposing sides of the vehicle. The plurality of side units 40 comprises ten side units 40 that are positioned five-apiece on each opposing side of the vehicle, as shown in FIG. 5.

The plurality of sensing and imaging modules 12 also comprises a pair of side mirror units 42, as shown in FIG. 5. Each side mirror unit 42 is mounted to a respective side mirror of the vehicle. The forward units 36, the rearward units 38, the side units 40, and the side mirror units 42 are configured to detect the object moving in an area proximate to the vehicle to capture the image of the object. Should the object, such as another vehicle, a shopping cart, bicycle, or the like, contact the vehicle, the contact would be documented and a responsible party assigned.

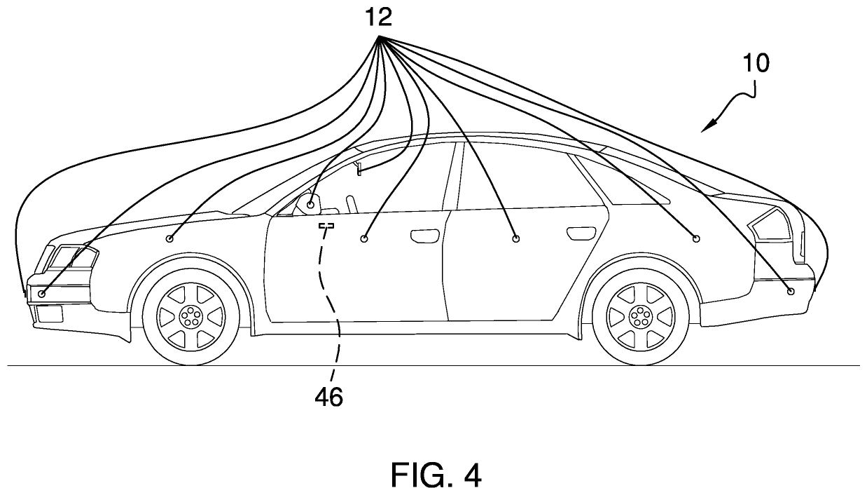

The plurality of sensing and imaging modules 12 also comprises a plurality of inside units 44 that is mounted to an interior of the vehicle, as shown in FIG. 4. The inside units 44 are configured to detect a person moving in the vehicle and to capture an image of the person. The plurality of inside units 44 comprises one inside unit 44 that is positioned on a rearview mirror of the vehicle.

The assembly 10 comprises a control unit 46, which comprises a receiver 48. The receiver 48 is positioned to receive the images from the plurality of sensing and imaging modules 12. The control unit 46 comprises a second housing 50 that defines an internal space 52. The receiver 48 is coupled to the housing and is positioned in the internal space 52.

A second power module 54 is coupled to the second housing 50 and is positioned in the internal space 52. The receiver 48 is operationally coupled to the second power module 54. The second power module 54 comprises a second battery 56. The second battery 56 is rechargeable. A second microprocessor 58 is coupled to the second housing 50 and is positioned in the internal space 52.

A cord 60 is coupled to and extends from the second housing 50. The cord 60 is operationally coupled to the second microprocessor 58. The cord 60 is operationally coupled to the second battery 56. A connector 62 is coupled to the cord 60 distal from the second housing 50. The connector 62 is configured to couple the cord 60 to the source of direct current to power the second microprocessor 58. The connector 62 also is configured to couple the cord 60 to the source of direct current to charge the second battery 56.

A data storage module 64 is coupled to the second housing 50 and is positioned in the internal space 52. The data storage module 64 comprises a card port 66 and a memory card 68. The card port 66 is coupled to the second housing 50 and extends into the internal space 52. The card port 66 is positioned to selectively insert the memory card 68 to couple the memory card 68 to the second housing 50 and to operationally couple the memory card 68 to the second microprocessor 58.

The second microprocessor 58 is operationally coupled to the second power module 54, the data storage module 64, and the receiver 48. The receiver 48 is positioned to relay the images from the plurality of sensing and imaging modules 12 to the second microprocessor 58. The second microprocessor 58 is positioned to transfer the images to the data storage module 64.

A button 70 is coupled to the second housing 50. The button 70 is depressible. The button 70 is operationally coupled to the second microprocessor 58, the second power module 54, and the cord 60. The button 70 is configured to be depressed a first time to selectively couple the second microprocessor 58 to the second power module 54 and the cord 60 to power the second microprocessor 58. The button 70 is configured to be depressed a second time to selectively decouple the second microprocessor 58 from the second power module 54 and the cord 60.

An audio jack 72 is coupled to the second housing 50. The audio jack 72 is operationally coupled to the second microprocessor 58. The audio jack 72 is positioned to insert a plug of an audio player to position the second microprocessor 58 to transmit a respective audio file from the data storage module 64 to the audio player.

A plurality of connecting ports 74 is coupled to the second housing 50. Each connecting port 74 is operationally coupled to the second microprocessor 58 and is configured to selectively couple the second microprocessor 58 to an electronic device of a user. The user is positioned to install programming code on the second microprocessor 58 and to transfer the images from the data storage module 64 to the electronic device. Each connecting port 74 comprises a Universal Serial Bus port 76. The plurality of connecting ports 74 comprises two connecting ports 74.

The present invention anticipates the control unit 46 being integrated with a communication system of the vehicle, such as a cellular communication system. Images from the data storage module 64 would be transmitted via the communication system to a cloud storage network and would be accessible to the user for remote viewing. The present invention also anticipates the control unit 46 being integrated with a theft detection system of the vehicle. Upon unauthorized starting of the vehicle, the images capture by the plurality of sensing and imaging modules 12 would provide a means of locating the vehicle and identifying the driver and any passengers.

In use, the plurality of sensing and imaging modules 12 is coupled to the vehicle. The imaging modules are configured to detect the object moving in the area proximate to the vehicle, to capture the image of the object, and to transmit the images to the control unit 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle mounted imaging assembly comprising:
a plurality of sensing and imaging modules, each said sensing and imaging module comprising:
a first housing defining an interior space,
a coupler coupled to said first housing wherein said coupler is configured for coupling said first housing to a vehicle,
a first power module coupled to said first housing and positioned in said interior space,
a first microprocessor coupled to said first housing and positioned in said interior space, said first microprocessor being operationally coupled to said first power module,
an imager coupled to said first housing, said imager being operationally coupled to said first microprocessor wherein said first microprocessor is positioned for actuating said imager for capturing an image of an area proximate to said first housing,
a motion detector coupled to said first housing, said motion detector being operationally coupled to said first microprocessor wherein said motion detector is configured for detecting an object moving in the area proximate to said first housing positioning said first microprocessor for actuating said imager for capturing the image of the object, and
a transmitter coupled to said first housing and positioned in said interior space, said transmitter being operationally coupled to said first microprocessor wherein said first microprocessor is positioned for actuating said transmitter for transmitting the image; and
a control unit comprising a receiver wherein said receiver is positioned for receiving the images from said plurality of sensing and imaging modules.

2. The assembly of claim 1, further including said first housing being substantially disc shaped.

3. The assembly of claim 1, further including said first power module comprising a first battery.

4. The assembly of claim 3, further comprising:
said first battery being rechargeable; and
a charging port coupled to said first housing, said charging port being operationally coupled to said first battery wherein said charging port is configured for coupling said first battery to a source of direct current for charging said first battery.

5. The assembly of claim 1, further including said imager comprising an audiovisual camera wherein said audiovisual camera is configured for capturing an audiovisual image of the area proximate to said first housing.

6. The assembly of claim 1, further including a photosensor coupled to said first housing, said photosensor being operationally coupled to said first microprocessor wherein said photosensor is configured for measuring a light level proximate to said first housing positioning said first microprocessor for selectively actuating said imager for night vision mode.

7. The assembly of claim 1, further including said plurality of sensing and imaging modules comprising:
a plurality of forward units mounted to a front of the vehicle;
a plurality of rearward units mounted to a back of the vehicle;
a plurality of side units mounted to opposing sides of the vehicle; and
a pair of side mirror units, each said side mirror unit being mounted to a respective side mirror of the vehicle, wherein said forward units, said rearward units, said side units, and said side mirror units are configured for detecting the object moving in an area proximate to the vehicle for capturing the image of the object.

8. The assembly of claim 7, further comprising:
said plurality of forward units comprising five said forward units;
said plurality of rearward units comprising three said rearward units; and
said plurality of side units comprising ten said side units positioned five-apiece on each opposing side of the vehicle.

9. The assembly of claim 1, further including said plurality of sensing and imaging modules comprising a plurality of inside units mounted to an interior of the vehicle wherein said inside units are configured for detecting a person moving in the vehicle for capturing an image of the person.

10. The assembly of claim 9, further including said plurality of inside units comprising one said inside unit positioned on a rearview mirror of the vehicle.

11. The assembly of claim 1, further including said control using comprising:
a second housing defining an internal space, said receiver being coupled to said housing and positioned in said internal space;
a second power module coupled to said second housing and positioned in said internal space, said receiver being operationally coupled to said second power module;
a data storage module coupled to said second housing and positioned in said internal space; and
a second microprocessor coupled to said second housing and positioned in said internal space, said second microprocessor being operationally coupled to said second power module, said data storage module, and said receiver wherein said receiver is positioned for relaying the images from said plurality of sensing and imaging modules to said second microprocessor such that said second microprocessor is positioned for transferring the images to said data storage module.

12. The assembly of claim 11, further comprising:
a cord coupled to and extending from said second housing, said cord being operationally coupled to said second microprocessor; and
a connector coupled to said cord distal from said second housing wherein said connector is configured for coupling said cord to a source of direct current for powering said second microprocessor.

13. The assembly of claim 12, further comprising:
said second power module comprising a second battery, said second battery being rechargeable; and
said cord being operationally coupled to said second battery, wherein said connector is configured for coupling said cord to the source of direct current for charging said second battery.

14. The assembly of claim 11, further including said data storage module comprising a card port and a memory card, said card port being coupled to said second housing and extending into said internal space wherein said card port is positioned for selectively inserting said memory card for coupling said memory card to said second housing and for operationally coupling said memory card to said second microprocessor.

15. The assembly of claim 12, further including a button coupled to said second housing, said button being depressible, said button being operationally coupled to said second microprocessor, said second power module, and said cord wherein said button is configured for depressing a first time for selectively coupling said second microprocessor to said second power module and said cord for powering said second microprocessor, wherein said button is configured for depressing a second time for selectively decoupling said second microprocessor from said second power module and said cord.

16. The assembly of claim 11, further including an audio jack coupled to said second housing, said audio jack being operationally coupled to said second microprocessor wherein said audio jack is positioned for inserting a plug of an audio player positioning said second microprocessor for transmitting a respective audio file from said data storage module to the audio player.

17. The assembly of claim 11, further including a plurality of connecting ports coupled to said second housing, each said connecting port being operationally coupled to said second microprocessor wherein connecting port is configured for selectively coupling said second microprocessor to an electronic device of a user positioning the user for installing programming code on said second microprocessor and for transferring said images from said data storage module to the electronic device.

18. The assembly of claim 17, further including each said connecting port comprising a Universal Serial Bus port.

19. The assembly of claim 17, further including said plurality of connecting ports comprising two said connecting ports.

20. A vehicle mounted imaging assembly comprising:
a plurality of sensing and imaging modules, each said sensing and imaging module comprising:
a first housing defining an interior space, said first housing being substantially disc shaped,
a coupler coupled to said first housing wherein said coupler is configured for coupling said first housing to a vehicle,
a first power module coupled to said first housing and positioned in said interior space, said first power module comprising a first battery, said first battery being rechargeable,
a charging port coupled to said first housing, said charging port being operationally coupled to said first battery wherein said charging port is configured for coupling said first battery to a source of direct current for charging said first battery,
a first microprocessor coupled to said first housing and positioned in said interior space, said first microprocessor being operationally coupled to said first power module,
an imager coupled to said first housing, said imager being operationally coupled to said first microprocessor wherein said first microprocessor is positioned for actuating said imager for capturing an image of an area proximate to said first housing, said imager comprising an audiovisual camera wherein said audiovisual camera is configured for capturing an audiovisual image of the area proximate to said first housing,
a motion detector coupled to said first housing, said motion detector being operationally coupled to said first microprocessor wherein said motion detector is configured for detecting an object moving in the area proximate to said first housing positioning said first microprocessor for actuating said imager for capturing the image of the object, and
a transmitter coupled to said first housing and positioned in said interior space, said transmitter being operationally coupled to said first microprocessor wherein said first microprocessor is positioned for actuating said transmitter for transmitting the image, and
a photosensor coupled to said first housing, said photosensor being operationally coupled to said first microprocessor wherein said photosensor is configured for measuring a light level proximate to said first housing positioning said first microprocessor for selectively actuating said imager for night vision mode;
said plurality of sensing and imaging modules comprising:
a plurality of forward units mounted to a front of the vehicle, said plurality of forward units comprising five said forward units,
a plurality of rearward units mounted to a back of the vehicle, said plurality of rearward units comprising three said rearward units,
a plurality of side units mounted to opposing sides of the vehicle, said plurality of side units comprising ten said side units positioned five-apiece on each opposing side of the vehicle,
a pair of side mirror units, each said side mirror unit being mounted to a respective side mirror of the vehicle, wherein said forward units, said rearward units, said side units, and said side mirror units are configured for detecting the object moving in an area proximate to the vehicle for capturing the image of the object, and
a plurality of inside units mounted to an interior of the vehicle wherein said inside units are configured for detecting a person moving in the vehicle for capturing an image of the person, said plurality of inside units comprising one said inside unit positioned on a rearview mirror of the vehicle; and
a control unit comprising a receiver wherein said receiver is positioned for receiving the images from said plurality of sensing and imaging modules, said control using comprising:
a second housing defining an internal space, said receiver being coupled to said housing and positioned in said internal space,
a second power module coupled to said second housing and positioned in said internal space, said receiver being operationally coupled to said second power module, said second power module comprising a second battery, said second battery being rechargeable,
a cord coupled to and extending from said second housing, said cord being operationally coupled to said second microprocessor, said cord being operationally coupled to said second battery,
a connector coupled to said cord distal from said second housing wherein said connector is configured for coupling said cord to the source of direct current for powering said second microprocessor, wherein said connector is configured for coupling said cord to the source of direct current for charging said second battery,
a data storage module coupled to said second housing and positioned in said internal space, said data storage module comprising a card port and a memory card, said card port being coupled to said second housing and extending into said internal space wherein said card port is positioned for selectively inserting said memory card for coupling said memory card to said second housing and for operationally coupling said memory card to said second microprocessor,
a second microprocessor coupled to said second housing and positioned in said internal space, said second microprocessor being operationally coupled to said second power module, said data storage module, and said receiver wherein said receiver is positioned for relaying the images from said plurality of sensing and imaging modules to said second microprocessor such that said second microprocessor is positioned for transferring the images to said data storage module,
a button coupled to said second housing, said button being depressible, said button being operationally coupled to said second microprocessor, said second power module, and said cord wherein said button is configured for depressing a first time for selectively coupling said second microprocessor to said second power module and said cord for powering said second microprocessor, wherein said button is configured for depressing a second time for selectively decoupling said second microprocessor from said second power module and said cord,
an audio jack coupled to said second housing, said audio jack being operationally coupled to said second microprocessor wherein said audio jack is positioned for inserting a plug of an audio player positioning said second microprocessor for transmitting a respective audio file from said data storage module to the audio player, and
a plurality of connecting ports coupled to said second housing, each said connecting port being operationally coupled to said second microprocessor wherein connecting port is configured for selectively coupling said second microprocessor to an electronic device of a user positioning the user for installing programming code on said second microprocessor and for transferring said images from said data storage module to the electronic device, each said connecting port comprising a Universal Serial Bus port, said plurality of connecting ports comprising two said connecting ports.
